(19) United States
(12) Patent Application Publication
(10) Pub. No.: US 2022/0351277 A1
(43) Pub. Date: Nov. 3, 2022

(54) Multimedia Sales Platform

(71) Applicant: LIVESCALE TECHNOLOGIES INC., Montreal (CA)

(72) Inventors: Laurent BOUTET, Montreal (CA); Meher GARA, Montreal (CA); Virgile OLLIVIER, Outremont (CA)

(21) Appl. No.: 17/725,644

(22) Filed: Apr. 21, 2022

Related U.S. Application Data
(63) Continuation of application No. PCT/CA2020/051414, filed on Oct. 22, 2020.
(60) Provisional application No. 62/924,317, filed on Oct. 22, 2019.

(51) Int. Cl. G06Q 30/06; G06Q 30/00; H04N 21/472

(52) U.S. Cl. CPC G06Q 30/0641; G06Q 30/016; H04N 21/472

(57) ABSTRACT

The present disclosure provides a sales event streaming system and platform comprising a video broadcasting module, a user interface module having a financial information transmission module communicating directly with an e-commerce platform, a build module and a control module. The controller comprises a processor and a non-transitory computer-readable medium containing instructions that, when executed by the processor, cause the processor to receive a multimedia and sales platform content and provide them on the same interface without need to integrate two sources with each other.

The present application claims priority of U.S. provisional patent application Ser. No. 62/924,317 filed Oct. 22, 2019, the content of which is hereby incorporated by reference.

### TECHNICAL FIELD

The present application relates to the field of media streaming and online sales systems, for example, video sales platforms.

### BACKGROUND

Online shopping is becoming more and more popular and represents a huge portion of today's retail market. This is more evident as people and different generations become more comfortable using the internet to manage their affairs.

On the other hand, having TV events or even channels dedicated to sales of a particular product or brand has been known in the art for a long time. Generally, in such events, a TV channel showcases various products that viewers can purchase either by telephone or by going to the vendor or manufacturer website over the internet and making their orders. This approach ensures that the financial information of the customer is shared only with the vendor or their third-party sales e-commerce service provider (e.g., Sales Force, Shopify, Sap) and not with the TV channels and other institutions installed.

Although having a system with simultaneous online event broadcasting and online shopping capabilities under the same platform is desirable, there exists problems in terms of privacy, security, handling and compliance of the financial information of the clients which makes it difficult for a broadcasting platform to provide sales capability without requiring the customer to go to a different platform. An example of such compliance requirements is the Payment Card Industry Data Security Standard (PCI DSS) which is designed to help you prevent the theft of confidential consumer cardholder data by assessing whether that data is secure within your organization and, if necessary, improving your level of security to meet or exceed industry standards.

As a result, the online broadcasting and shopping platforms normally have to be designed for a specific company based on their e-commerce platform which may be both time consuming, due to compliance requirements,

Furthermore, integrating the existing platform would require the vendor to integrate their e-commerce and their broadcasting platforms together.

Therefore, there exists a need for a system and platform capable of broadcasting the events and providing online sales services without retaining the customers' financial information.

Furthermore, there exists a need for an online broadcasting platform that could work with the vendors' existing e-commerce platform without the need for integration or redirection of the customers to a different website.

### SUMMARY

The present disclosure provides, among others, solutions addressing the above-mentioned problems with the existing systems. This patent application provides complementary improvements that may be applied separately or in combination.

Applicant has found that a media streaming event and one or more online shopping platforms can be collected from a number of different sources and delivered on the one live sale platform, while no integration of the information from the existing online shopping system into the live sales platform is required and the live sales platform receives and updates all the sales details and information from the e-commerce platforms or the vendor/manufacturer website automatically.

The applicant has found that media streaming events and information from online shopping platforms can be collected from different sources and delivered on the one live sale platform, while the financial transactions can be handled by the existing e-commerce platforms without the live sales platform retaining any information.

In one broad aspect, the present disclosure provides a multimedia sales platform or a sales and event streaming platform that includes a remote computing device which comprises a processor; and a non-transitory computer-readable medium containing instructions that when executed by the processor, cause the processor to perform receiving from a vendor instructions regarding a sale event, the instructions comprising: a source and configuration details for receiving a video stream for the event; one or more corresponding e-commerce platform addresses, and credentials for the one or more corresponding e-commerce platforms, receiving content for the sales event from at least one of the one or more e-commerce platforms using the credentials or a vendor shopping platform, delivering both the video and the online shopping content to users on the same web browser or computer application and providing instruction to the user interface to receive financial information required for performing a transaction and communicating the financial information to the e-commerce platform using the credentials without retaining the financial information.

In some embodiments, the platform may be operative as a cloud-based service to receive the vendor instruction over a computer network from different vendors.

In some embodiments of the platform, the non-transitory computer-readable medium may further contain instructions that cause the processor to perform receiving, from a vendor interface, vendor instructions regarding a schedule for the event.

In some embodiments, the non-transitory computer-readable medium may further contain instructions that cause the processor to perform: providing tags used for tracking and analytics on the browser or application to the vendor interface.

In some embodiments of the platform, the non-transitory computer-readable medium may further contain instructions that cause the processor to perform providing a live chat between the vendor and one or more users.

In some embodiments of the platform, the non-transitory computer-readable medium may contain instructions that cause the processor to perform, providing the vendor, a hyperlink to the web browser or computer application.

In one other broad aspect, the present disclosure provides a multimedia sales or sales event streaming system comprising a video broadcasting module, a user interface module having a financial information transmission module communicating directly with an e-commerce platform, a build module and a control module. The control module comprising a processor; and a non-transitory computer-readable medium containing instructions that, when executed by the processor, cause the processor to perform: receiving by the build module, vendor instructions regarding a sales event and providing the instructions to the user interface module, the instructions comprising: configuration details for receiving a video stream for the video broadcasting module; one or more corresponding e-commerce platform address and credentials for the one or more corresponding e-commerce platforms; receiving content for the sales event from at least one of the e-commerce platforms using the credentials or the vendor interface online shopping; and delivering both the video and the online shopping content on the user face; providing instruction to the user interface to receive financial information required for performing a transaction and communicating the financial information to the e-commerce platform using the credentials without retaining the financial information.

In some examples, the sales event may have only one e-commerce platform in the back-end while in some examples it may have more than one e-commerce in its back-end. For example, several products may be provided by one e-commerce platform and the rest by a second e-commerce platform.

In some embodiments, the system may be operative as a cloud-based service to receive the vendor instruction over a computer network from different vendors.

In some embodiments, the non-transitory computer-readable medium may further contain instructions that cause the processor to perform: receiving, from a vendor interface module, vendor instructions and transferring the instructions to the build module.

In some embodiments, the non-transitory computer-readable medium may further contain instructions that cause the processor to perform: providing tags used for tracking and analytics on the user interface to the vendor.

In some embodiments, the system may further comprise a tag management module receiving the tags and allowing the vendor to manage the tags.

In some embodiments, the system may further comprise a tag management module, wherein the non-transitory computer-readable medium further contains instructions that cause the processor to perform: receiving the tags by the tag management module and allowing the vendor to manage the tags.

In some embodiments of the system, the non-transitory computer-readable medium may further contain instructions that cause the processor to perform: providing a live chat between the vendor and one or more users.

In some embodiments of the system, the non-transitory computer-readable medium may further contain instructions that cause the processor to perform: providing the vendor, a hyperlink to the web browser or computer application.

A portion of the disclosure of this patent document contains material that is subject to copyright protection. The copyright owner has no objection to the facsimile reproduction by any one of the patent documents or the patent disclosure, as it appears in the Patent and Trademark Office patent files or records, but otherwise reserves all copyright rights whatsoever.

### BRIEF DESCRIPTION OF THE DRAWINGS

The present examples will be better understood with reference to the appended illustrations which are as follows:

FIG. 1 is a schematic illustration of a live sale platform in accordance with one embodiment of the present disclosure;

FIG. 2 is a schematic illustration of a live sale platform having an external Tag Management System in accordance with one embodiment of the present disclosure;

FIG. 3 is a schematic illustration of a live sale platform having an internal Tag Management System and a vendor interface in accordance with one embodiment of the present disclosure;

FIG. 4 shows a sequence diagram of the multimedia shopping platform and system disclosed according to one embodiment of the present invention.

FIG. 5 shows a screenshot of a main page of a mobile application providing a live event with possibility of purchasing product by connecting directly to one or more e-commerce platforms in accordance with one embodiment of the present invention.

FIG. 6 shows a screenshot of a product page of the platform shown in FIG. 5 which provides product options and purchase option in accordance with one embodiment of the present invention.

FIG. 7 shows a screenshot of a shopping cart check out page of the platform shown in FIG. 5 showing the products that are being purchased in accordance with one embodiment of the present invention.

FIG. 8 shows a screenshot of a shipping information page of the platform shown in FIG. 5 in accordance with one embodiment of the present invention.

FIG. 9 shows a screenshot of an order review page of the platform shown in FIG. 5 in accordance with one embodiment of the present invention.

### DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the scope of the invention. Thus, it is intended that the present invention cover the modifications and variations of this invention provided they come within the scope of the appended claims and their equivalents. Reference will now be made in detail to the preferred embodiments of the invention.

Generally, having a platform capable of both multimedia streaming and providing online sales capabilities requires integration of a live-streaming module with one or more e-commerce platform together.

The present disclosure provides a system and platform capable of receiving multimedia streams from one or multiple sources, receiving online sales content from different sources, providing a customer with both on the same interface and performing the online financial transaction using an existing e-commerce platform of the vendor without retaining any financial information of the customer/user.

This invention provides multiple improvements and resolves problems faced by vendors trying to sell their products through an online platform while providing a live sale event. As explained in this application some of these improvements are, inter alia, easy integration of different content and multimedia sources with the e-commerce platform being used by the vendor and avoiding some compliance requirement for handling consumers' financial information.

An example of such multimedia broadcasting system is disclosed in the Applicant's US patent application publication US2019/0289052A1 published on 19 Sep. 2019. As disclosed therein, the platform provides a vendor to publish the same live event on several multimedia outlets simultaneously and receive from the platform desired performance metrics.

In some examples, when a user wants to set an event, the following HTML code may be used to call “app.js” (e.g. a Java script app), in this example, to implement the platforms and event settings:

```
  <!DOCTYPE html>
  <html lang=“en”>
  <head>
    <meta charset=“UTF-8” />
    <title>Event Title</title>
    <meta name=“viewport”
      content=“width=device-width, initial-scale=1, maximum-scale=1, maximum-scale=1, user-
  scalable=0” />
    <link rel=“manifest” href=“icons/manifest.json” />
    <meta name=“theme-color” content=“#FFFEFE” />
    <!-- Open Graph Data for link sharing -->
    <meta property=“og:title” content=“Event Title” />
    <meta property=“og:url” content=“https://shop.livescale.tv/event_id” />
    <meta property=“og:site_name” content=“Event Title” />
    <meta property=“og:image”
      content=“https://shop.livescale.tv/event_id/banner/17f9fb41-8d18-4744-ff8a-
  48f3ed4d18dd_desktop_900.png” />
    <meta property=“og:type” content=“website” />
    <meta property=“og:description” content=“Welcome !” />
    <!-- CSS Loading -->
    <link href=https://diva.livescale.tv/shop/css/app.css rel=stylesheet>
  <body id=“bod”>
    <!-- Warning when JavaScript is disabled -->
    <noscript>
      <strong>We're sorry but the app doesn't work properly without JavaScript
        enabled. Please enable it to continue.</strong>
    </noscript>
    <!-- Application Loading -->
    <div id=“app”></div>
    <script src=https://diva.staging.livescale.tv/shop/js/app.js></script>
  </body>
</html>
```

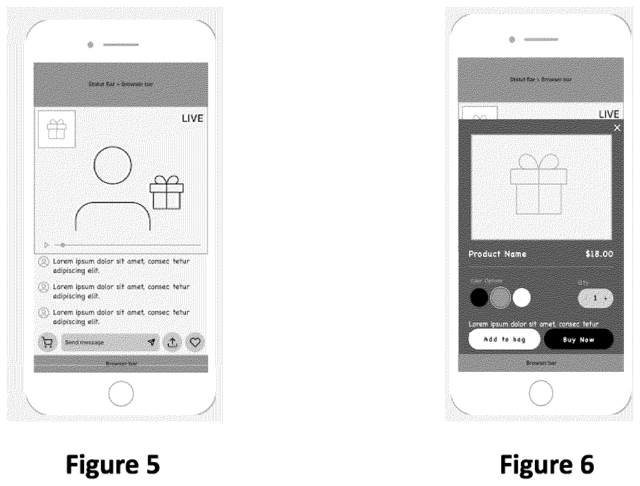

FIG. 5 is an example of the main page of a mobile application providing a live event with possibility of purchasing product by connecting directly to one or more e-commerce platforms. FIG. 6 shows a product page of the same platform which provides the product options and purchase options as defined by the vendor.

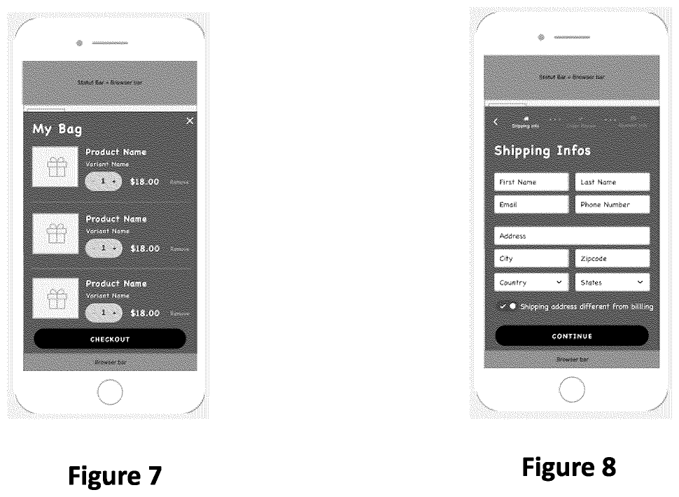

FIG. 7 is again a shopping cart check out page of the same platform shown as illustrated in FIGS. 5 and 6 with products that are being purchased.

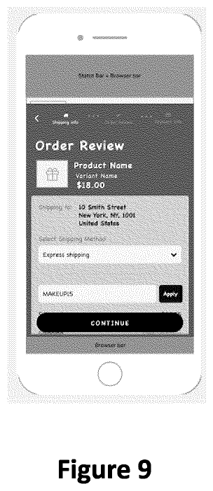

In FIG. 8 an exemplary shipping information page of the platform is shown while FIG. 9 shows an order review page of the platform shown in FIG. 5 in accordance with one embodiment of the present invention.

App.js is a lightweight JavaScript UI library for creating mobile webapps that behave like native apps.

In some embodiments, the platform and system may receive information from a retailer, vendor, or manufacturing (herein referred to as “vendor”) regarding the source of the video and details regarding the schedule, content and other information regarding the video stream in order to set up the event.

The platform also receives information regarding the content of the platform such as the merchandise, goods or service to be sold or provided for other options provided on the platform for other purposes such as donation, charity contribution, etc. during the event. An example of this would be an online sales event for a beauty product with the option of purchasing the merchandise on the same page or a relate page that video is playing or an online fundraising event where people can make their donation directly on the same platform.

In some examples, the platform typically integrates at least three different types of backends for multimedia, chat, and e-commerce transactions. The following is an exemplary extract of a setting file or script used by the app executed in the browser app that may be used for setting up an online sales event showing the status of the event, information about the event such as the event name, start time, ID etc., choosing the source of the live video feed (HLS via CDN in this example), choosing a chat configuration with backend URL & channel ID.

```
{
  “_comment_1”: “status is the lifecycle of the live shopping event (Scheduled, Live,
Ended)”,
  “status”: “LIVE”,
  “_comment_2”: “Information about the event (name, ID, start time, ...)”,
  “event_properties”: {
    “name”: “Event Title”,
    “pre_message”: “Welcome message”,
    “post_message”: “Thank you message”,
    “banner”: “https://shop.livescale.tv/event_id/banner/banner.png”,
    “event_id”: “UVyCR4hantqN6EwAtNme”,
    “start_time”: “2019-10-22T00:00:00.000Z”
  },
  “_comment_3”: “video_manifest is the URL of the live video feed (HLS via CDN in this
example)”,
  “video_manifest”: [
    “https://cdn.livescale.tv/us-central1/UVyCR4hantqN6EwAtNme/0/hls/stream.m3u8”
“_comment_4”: “Chat configuration with backend URL & channel ID”,
  “chat_config”: {
    “url”: “https://chat.livescale.tv/api/v1”,
    “channel”: “8PyLaEeXZorQwSksMeBb”
```

In some embodiments, the vendor may want to add some optional features to the live sales event. For example, a quiz can be set using the platform. The following is an example of such optional features setting.

```
  “_comment_5”: “Quizz configuration with backend URL & channel
  ID”,
“quizz_config”: {
  “url”: “https://quizz.livescale.tv/api/v1”,
  “channel”: “f8AeCRaEWTgRKLuL8u3i”
```

The vendor or user may also set up a list of the multimedia platform outlets. The following of what the platform may use to implement such setting:

```
“_comment_6”: “providers is an array containing one or multiple
providers (e-commerce backends)”,
  “providers”: [
    {
```

In some embodiments, this information regarding the content of the platform, aside from the video stream, may be loaded to the platform through an e-commerce platform such as Sap, Salesforce, Magento, Shopify, 3dcart, WooCommerce, Volusion, Prestashop, Weebly, Squarespace. In such cases, the vendor provides the required information regarding the e-commerce platform from which the information has to be obtained. This information may include a list of items, services, credentials for logging to the e-commerce platform, etc.

Using the following settings the platform allows the vendor to set up e-commerce backends for products allowing the same event for a sales catalogue to integrates multiple e-commerce backends.

```
        “_comment_7”: “_id is the ID of the provider. Used in the product catalog below so
    product can be on different e-commerce backends.”,
        “_id”: “1”,
        “owner”: “Vendor 1”,
        “_comment_8”: “provider_type is the type of the e-commerce. Application contains
    an abstraction to handle multiple types (ex: Salesforce, Shopify, BIGCommerce,
    Woocommerce, ...)”,
        “provider_type”: “salesforce”,
        “_comment_9”: “Provider (e-commerce) configuration with backend URL & client
    ID”,
        “config”: {
          “basePath”: “https://www.salesforce.com/s/vendor1-us/dw/shop/v20_3”,
          “x-client-id”: “66631f76-cee9-48c9-a12d-6a01433752af”
        },
“_comment_11”: “Catalog of products being sold during the live shopping event.”,
  “_comment_12”: “Products can be on different providers (e-commerce) with provider_id
refering to section above”,
  “catalog”: [
    {
      “name”: “Product 1”,
      “shortDescription”: “This is a short description”,
      “longDescription”: “This is a long description”,
      “image”: “https://www.vendor1.com/images/5893345625548.jpg”,
      “sku”: “5893345625548”,
      “price”: “35.00”,
      “currency_code”: “USD”,
      “provider_id”: 1
    },
    {
      “name”: “Product 2”,
      “shortDescription”: “This is a short description”,
      “longDescription”: “This is a long description”,
      “image”: “https://www.vendor2.com/images/3102438001323.jpg”,
      “sku”: “3102438001323”,
      “price”: “75.00”,
      “currency”: “CAD”,
      “provider_id”: 2
    },
    {
      “name”: “Product 3”,
      “shortDescription”: “This is a short description”,
      “longDescription”: “This is a long description”,
      “image”: “https://www.vendor1.com/images/9854352200958.jpg”,
      “sku”: “9854352200958”,
      “price”: “18.00”,
      “currency”: “USD”,
      “provider_id”: 1
    }
  ]
```

The platform further receives and sets up an array of supported payment providers URL, client ID and payment provider type, Cybersource, Stripe, Paypal, Apple Pay, Google Pay, Bitcoin, which can be used by a user.

```
“_comment_10”: “Array of supported payment providers URL, client ID & payment
provider type (Cybersource, Stripe, Paypal, Apple Pay, Google Pay, Bitcoin, ...)”,
    “payment_providers”: [
      {
        “psp_type”: “cybersource”,
        “basePath”: “https://www.cybersource.com/api/v1/token”,
        “x-client-id”: “d705fa55-eae3-4e41-8f2f-f1ceb799882b”
      }
    ]
  },
  {
    “_id”: “2”,
    “owner”: “Vendor 2”,
    “provider_type”: “shopify”,
    “config”: {
      “basePath”: “https://www.shopify.com/s/vendor2-ca/sh/shop/v2_4”,
      “x-client-id”: “8458053b-c513-4926-bc13-d9349e1ed790”
    },
    “payment_providers”: [
      {
        “psp_type”: “stripe”,
        “basePath”: “https://www.stripe.com/api/v1/token”,
        “x-client-id”: “acbe008e-4537-488b-a7ca-4176355e3a72”
      },
      {
        “psp_type”: “apple_pay”,
        “basePath”: “https://www.apple.com/api/v1/token”,
        “x-client-id”: “d705fa55-eae3-4e41-8f2f-f1ceb799882b”
      }
    ]
  }
```

In some embodiments, the platform receives the vendor's credentials for different e-commerce platforms and logs the vendor into multiple platforms without requiring the vendor to log in to each platform separately.

In one example, the platform implements the purchase through one or more e-commerce platforms by receiving the financial information of the purchaser and transmitting them to one or more e-commerce without retaining any of this information.

This can be done in different manners. For example, the platform can integrate the e-commerce section for the receipt of financial information and just transmit this information to the e-commerce platform without retaining any information. In another example, it may redirect the purchaser to the e-commerce platform to directly.

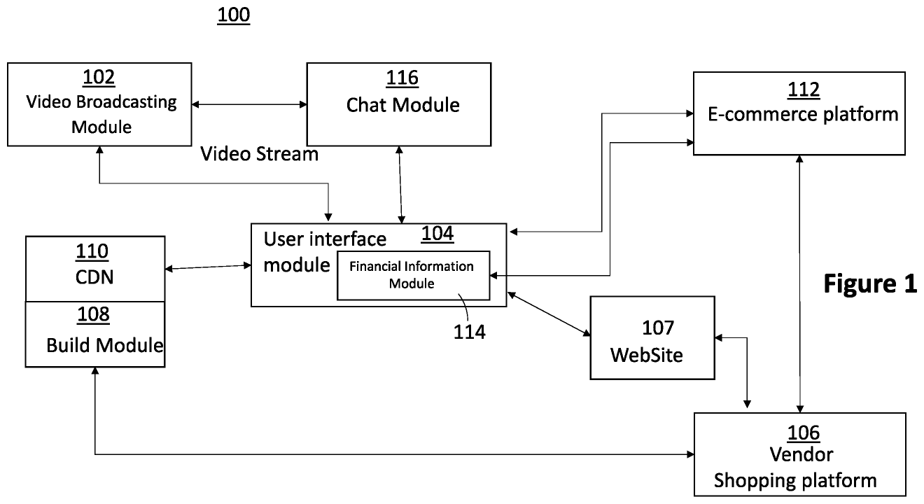

FIG. 1 illustrates an example of such a platform and system. A video broadcasting module 102 provides the video stream to a user interface 104 which may be provided on the user interface 104, which may be a browser, in a computer application or any other means of providing the content. As illustrated, a vendor platform 106 may provide a build module 108 with the content of the sale event including the information regarding the merchandise or services to be provided as described before.

It would be appreciated by those skilled in the art that the build module 108 may be an independent module working with a content delivery network (“CDN”) 110 or an integral part the CDN 110. The CDN 110 received the content from the build module 108 and delivers this content to the user interface 104.

It will be appreciated by those skilled in the art that in addition to the details regarding an e-commerce platform 112 used by the vendor, this content received by the user interface 104 may include the credentials required for the platform 104 to communicate with the e-commerce platform 112.

In some embodiments, the vendor platform 106 may communicate with one or more e-commerce platforms 112 to provide information regarding the items and content of the sale event directly through the e-commerce platforms 112.

In one embodiment, the system provides a vendor with a hyperlink that can be advertised and provided to a user or customer through different means including the vendor's website or through video broadcasting module 102 as disclosed in Applicant's US patent application publication US2019/0289052A1 published on 19 Sep. 2019. When the user clicks on the hyperlink, it will be redirected to the user interface platform 104. The user interface 104 provides the end user with the video stream received from the video module 102 and the sales event content received from the e-commerce platform 112 or CDN 110. When the user wants to purchase a product or service or make a financial transaction, a financial information module 114 receives the information and communicates that information directly with the e-commerce platform 112 without retaining any of the financial information or, in some embodiments, without communicating it with the other parts of the user interface 104. This communication between the platform 112 and the financial information module 114 performs encrypted Application Programming Interface (API) calls, using known communication protocol such as HHTPS/TLS.

It would be appreciated by those skilled in the art that despite its illustration as a separate block, the financial module 114 may work as a series of instruction served by the CDN 110 to the user interface 104 allowing the user interface 104 to receive the financial information of a customer and communicate it to the e-commerce platform 112.

In some embodiments, the platform 100 may further provide a chat module 116 allowing one or more users to chat with each other, the vendor or other parties involved in the sales event broadcasting. The chat module 116 may be a separate module communicating with the video broadcasting module 102 or an integrated part of this module.

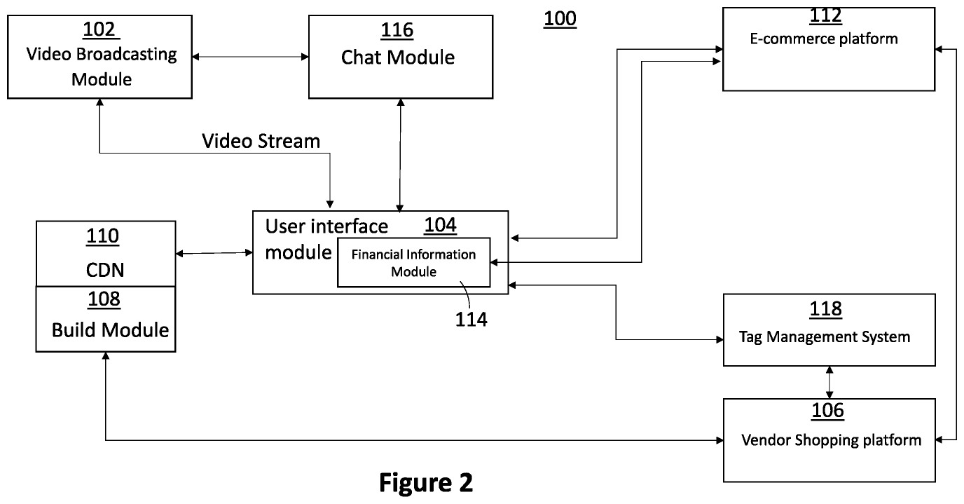

FIG. 2 shows an embodiment of the present disclosure that communicates, receives and provides the tags (tags, triggers, data layers, variables, profiles) used for digital marketing purposes, including the tags used for tracking and analytics, to an external tag management system 118 such as Google Tag Manager, Adobe Dynamic Tag Management, Tealium iQ, Tag Commander, etc. This allows a vendor to supervise information regarding the sales and conduct analysis of their sales information. This information may be then sent from the tag management system to the vendor shopping platform 106.

In some embodiments, the system may also collect information regarding the number of viewers, their geographical locations, the platform from which they received the hyperlink, the information regarding the frequency of their participation in the events, etc. and provide it back to the vendor or to the video broadcasting module 102.

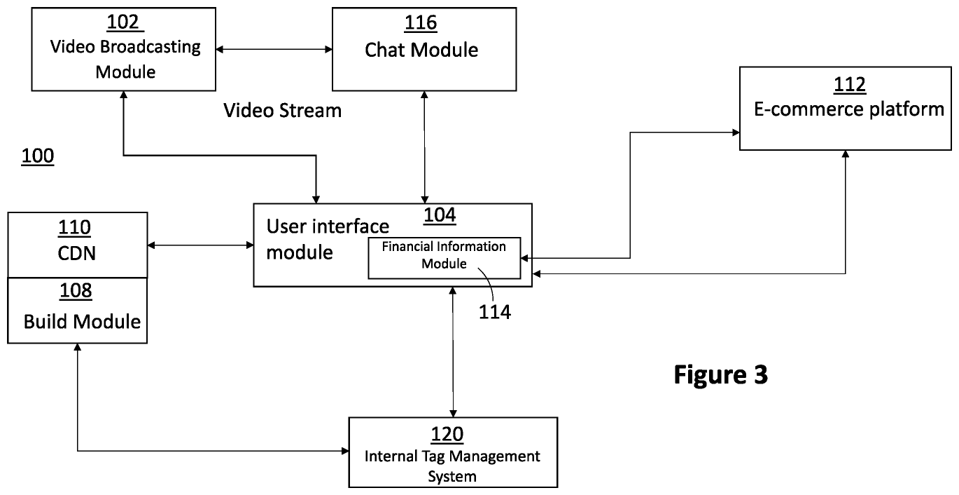

FIG. 3 illustrates an embodiment in which the platform has an internal tag management system 120 may be implemented to provide the vendor with a tag management system.

In some embodiments, the vendor may directly use the build module as an internal interface to set up the content for the sales event, video streaming and receive information about the sales analytics. This has the benefit of providing smaller vendors that don't have an existing shopping platform with a platform to conduct their sales without requiring to set up such a website/platform.

In some embodiments, platform 100 may be used by a vendor to set up a temporary e-commerce profile for a vendor that does not have such a platform, on a temporary basis for use during the sales event. While not limiting but such a setting would be more practical for financial transaction part of the online sales process.

In one embodiment, the connection between the user interface 104 and the e-commerce platforms 112 is only used to conduct the financial transaction and all the content of the sales event can be provided and set up on the user interface 104 using the internal vendor interface 122.

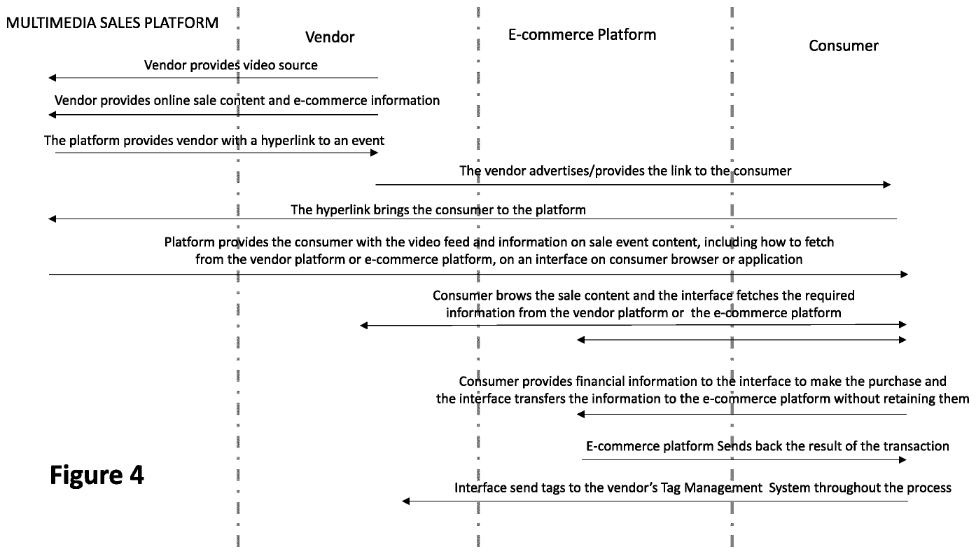

As illustrated in FIG. 4 a sequence diagram of the multimedia shopping platform and steps taken, according to one embodiment, by each party involved is illustrated. It will be appreciated that tags can be sent to the tag analysis module, internal or external, as required. Typically, the vendor provides a video source to the platform and sets up a source that provides online sale content and e-commerce information. This can be data about the place from which the information can be fetched. Then the platform provides the consumer with the video feed and information on sale event content, including how to fetch from the vendor platform or e-commerce platform on an interface on consumer browsers or applications. Then, the consumer or user browse the sale content and the interface fetches the required information from the vendor platform or e-commerce platform.

If the consumer decided to make a purchase, the consumer provides financial information to the interface to make the purchase and the interface transfers the information to the e-commerce platform without retaining them and the e-commerce platform sends back the result of the transaction. The tags can be sent back to the multimedia sales platform or the vendor tag management system upon request.

1. A multimedia sales platform comprising:
a remote computing device comprising:
a processor; and
a non-transitory computer-readable medium containing instructions that, when executed by the processor, cause the processor to perform:
receiving vendor instructions regarding a sale event, the instructions comprising: a source and configuration details for fetching a video stream for the event; one or more corresponding e-commerce platforms addresses and credentials for one or more corresponding e-commerce platforms;
providing information to a user interface for fetching content for the sale event from at least one of:
the one or more e-commerce platforms using the credentials; and
a vendor shopping platform;
delivering both a video and online shopping content to users on the user interface;
providing instruction to the user interface to receive financial information required for performing a transaction and communicating the financial information to the one or more e-commerce platforms using the credentials without retaining the financial information.

2. The platform as defined in claim 1, wherein a system is operative as a cloud-based service to receive a vendor instruction over a computer network from different vendors.

3. The platform as defined in claim 1, wherein the non-transitory computer-readable medium further contains instructions that cause the processor to perform receiving, from a vendor interface, vendor instructions regarding a schedule for the event.

4. The platform as defined in claim 1, wherein the non-transitory computer-readable medium further contains instructions that cause the processor to perform: providing tags used for tracking and analytics on a browser or application to a vendor interface.

5. The platform as defined in claim 1, wherein the non-transitory computer-readable medium further contains instructions that cause the processor to perform: providing a live chat between a vendor and one or more users.

6. The platform as defined in claim 1, wherein the non-transitory computer-readable medium further contains instructions that cause the processor to perform: providing a vendor, a hyperlink to the browser or application.

7. The platform as defined in claim 1, wherein the user interface is provided on a web browser.

8. The platform as defined in claim 1, wherein the user interface is provided on a computer application.

9. The platform as defined in claim 1, wherein the non-transitory computer-readable medium further contains instructions that cause the processor to perform: providing instruction to said user interface to encrypt the financial information before sending said financial information to the one or more e-commerce platforms.

10. The platform as defined in claim 1, wherein the receiving vendor instructions regarding a sale event comprises receiving one corresponding e-commerce platform address, and credentials for said one corresponding e-commerce platforms.

11. The platform as defined in claim 1, wherein the receiving vendor instructions regarding a sale event comprises receiving more than one corresponding e-commerce platform addresses, and credentials for the more than one corresponding e-commerce platforms.

12. A multimedia sales system comprising:
a video broadcasting module;
a build module;
a control module comprising:
a processor; and
a non-transitory computer-readable medium containing instruction that, when executed by the processor, cause the processor to perform:
receiving by the build module, vendor instructions regarding a sale event and providing the instructions to a user interface module, the instructions comprising: configuration details for receiving a video stream for the video broadcasting module; one or more corresponding e-commerce platform addresses and credentials for one or more corresponding e-commerce platforms;
providing configuration details to fetch content for the sale event from at least one of:
the one or more e-commerce platforms using the credentials; and
a vendor shopping platform;
delivering both a video and online shopping content on the user interface module;
providing instruction to the user interface module to receive financial information for performing a financial transaction and communicating the financial information to the one or more e-commerce platforms using the credentials without retaining the financial information.

13. The system as defined in claim 12, wherein a system is operative as a cloud-based service to receive a vendor instruction over a computer network from different vendors.

14. The system as defined in claim 12, wherein the non-transitory computer-readable medium further contains instructions that cause the processor to perform: receiving, from a vendor shopping platform, the vendor instructions and transferring the instructions to the build module.

15. The system as defined in claim 12, wherein the non-transitory computer-readable medium further contains instructions that cause the processor to perform: providing tags used for tracking and analytics on the user interface to a vendor.

16. The system as defined in claim 15, further comprising a tag management module receiving the tags and allowing the vendor to manage the tags.

17. The system as defined in claim 15, further comprising a tag management module, wherein the non-transitory computer-readable medium further contains instructions that cause the processor to perform: receiving the tags and allowing the vendor to manage the tags.

18. The system as defined in claim 12, wherein the non-transitory computer-readable medium further contains instructions that cause the processor to perform: providing a live chat between a vendor and one or more users.

19. The system as defined in claim 12, wherein the non-transitory computer-readable medium further contains instructions that cause the processor to perform: providing a vendor, a hyperlink to the web browser or computer application.

20. The system as defined in claim 12, wherein the receiving by the build module, vendor instructions regarding a sale event and providing the instructions to the user interface module comprises receiving one corresponding e-commerce platform address, and credentials for said one corresponding e-commerce platform.
